(19) United States
(12) Patent Application Publication
(10) Pub. No.: US 2024/0346473 A1
(43) Pub. Date: Oct. 17, 2024

(54) Interoperable On-chain and Off-chain Banking and Payments Systems

(71) Applicant: Akporefe Agbamu, Oakdale, MN (US)

(72) Inventor: Akporefe Agbamu, Oakdale, MN (US)

(21) Appl. No.: 18/634,935

(22) Filed: Apr. 13, 2024

Related U.S. Application Data
(60) Provisional application No. 63/459,178, filed on Apr. 13, 2023.

(51) Int. Cl. G06Q 20/10; G06Q 40/02

(52) U.S. Cl. CPC G06Q 20/108; G06Q 40/02

(57) ABSTRACT

A computer-implemented payment and banking system, includes a gateway microservice system comprising proxying, authenticating, logging, routing, and monitoring functionality for managing systems, requests, and responses, enabling the orchestration of communication between a plurality of upstream and downstream systems, an open and/or core banking system enabling functionality comprising authentication, transmission, and receipt of data and/or transactions between a plurality of upstream and downstream systems, an account management system synchronized with the open and/or core banking system facilitating actions comprising buying, selling, transferring, depositing, withdrawing, and exchanging of fungible assets, and a data storage system for storing, retrieving, updating, and synchronizing data.

### CROSS-REFERENCE

This application claims priority under 35 USC § 119 to U.S. Provisional Patent Application No. 63/459,178, filed on Apr. 13, 2023. The disclosure is included herein in its entirety at least by reference.

### FIELD OF INVENTION

The disclosed embodiments relate to on-chain and off-chain transactions systems, more particularly, systems and methods for interoperable on-chain (centralized) and off-chain (distributed/decentralized) banking and payments systems.

### DISCUSSION OF THE STATE OF THE ART

In the art of payments and banking, the infrastructure that executes, clears, and settles financial transactions is highly fragmented, siloed, centralized, and often varies by geography. Compounding the issue, verifying the identity of individuals and businesses for payments and banking leads to longer onboarding clearing processes. Inaccurate and untimely transaction clearing, settlement, and data reconciliations, require sizable back office and compliance expenditures, among others.

The inability to cross-verify and reconcile off-chain and on-chain beneficiary and/or recipient's account details, transactions, and balances in real time severely limits on-chain and off-chain clearing and settlement, especially during initial transactions parties transparently and consistently. Lack of interoperability between off-chain and on-chain payment and banking systems, negatively impacts on and off ramp transaction volumes, off-chain and on-chain risk underwriting, and increases clearing and settlement times for regional and cross-border transactions.

Moreover, the lack of systems and methods that integrate off-chain open and/or core banking systems with multi-currency on-chain and off-chain wallets and accounts systems, and on-chain payment technology—CBDCs, stablecoins, etc., and artificial intelligence, to enable interoperability and portability of traditional payment and banking systems to facilitate on-chain and off-chain transactions, limits the speed at which the existing financial system (off-chain) is modernized and integrated with blockchain-based (on-chain) payment and banking systems. Lastly, the inability to ensure the visibility, integrity, immutability, and validity of (meta) data related to on-chain and off-chain financial transactions compounds these limitations.

Therefore, what is needed in the art is an artificial intelligence-driven (cross-border) open banking and payment system, to accelerate the execution, clearing, settlement, and reporting of (cross-border) financial transactions. Such a system is disclosed and claimed herein.

### SUMMARY OF THE SYSTEM

In one embodiment of the invention, a computer-implemented payment and banking system is provided, comprising a gateway microservice system comprising proxying, authenticating, logging, routing, and monitoring functionality for managing systems, requests, and responses, enabling the orchestration of communication between a plurality of upstream and downstream systems, an open and/or core banking system enabling functionality comprising authentication, transmission, and receipt of data and/or transactions between a plurality of upstream and downstream systems, an account management system synchronized with the open and/or core banking system facilitating actions comprising buying, selling, transferring, depositing, withdrawing, and exchanging of fungible assets, and a data storage system for storing, retrieving, updating, and synchronizing data.

Also in one embodiment, the transaction management system facilitates activities comprising monitoring, screening, and/or reporting transactions. Also in one embodiment, the account management system is synchronized with at least one on-chain and off-chain identity and/or payment credential. Also in one embodiment, the (g) RPC nodes and APIs facilitate the transmission, receipt, reading, and writing of data via private, consortium, and/or public blockchain systems. Also in one embodiment, the smart contracts facilitate on-chain and/or off-chain actions and/or control of on-chain and/or off-chain fungible assets. Also in one embodiment, the messaging system utilizes standardized messaging protocols comprising ISO standards for interoperable communication. Also in one embodiment, the system processes are optimized utilizing supervised, semi-supervised, and/or unsupervised intelligence. Also in one embodiment, the near-frequency communication system enables at least two devices embedded or compatible with near-frequency technology to have single or multiplexed communication and data exchange via encrypted and unencrypted protocols. Also in one embodiment, the near-frequency communication system further comprises a module for embedding and integrating NFC specifications for wireless short-range data exchange into NFC-compatible systems.

In another aspect of the invention, a computer-implemented payment and banking system is provided, comprising a microservice middleware system with functionality comprising proxying, authenticating, logging, routing, and monitoring of systems, requests, and responses, managing upstream and downstream communication between a plurality of systems, an open and/or core banking system utilizing at least one upstream system to enable functionality comprising authentication, transmission, and receipt of data and/or transactions between a plurality of systems, a wallet and/or account system compatible with smart contracts systems facilitating on-chain and/or off-chain actions comprising buying, selling, exchanging, transferring, depositing, withdrawing, redeeming, and issuing of fungible and non-fungible assets, smart contracts systems facilitating on-chain and/or off-chain transactions and/or control of on-chain and/or off-chain fungible and non-fungible assets, (g) RPC nodes and APIs transmit and receive data via private, consortium, and/or public blockchain systems, and a centralized and/or decentralized storage system for storing, retrieving, updating, and synchronizing data.

Also in one embodiment, the transaction management system facilitates activities comprising monitoring, screening, and/or reporting transactions. Also in one embodiment, the wallet and/or account system is linked to at least one digital or physical identity and/or payment credential. Also in one embodiment, the near-frequency communication system enables at least two devices embedded or compatible with near-frequency technology to have single or multiplexed communication and data exchange via encrypted and unencrypted protocols. Also in one embodiment, the near-frequency system further comprises a communication module for embedding and integrating NFC specifications for wireless short-range data exchange into NFC-compatible systems. Also in one embodiment, the messaging system utilizes standardized messaging protocols comprising ISO standards for interoperable communication. Also in one embodiment, the system processes are optimized utilizing artificial intelligence.

In another aspect of the invention, a computer-implemented payment and banking system enabling stablecoin and CBDC issuance, redemption, and management is provided, comprising a gateway microservice system with functionality comprising proxying, authenticating, logging, routing, and monitoring for managing systems, requests, and responses, orchestrating communication between a plurality of upstream and downstream systems, an open and/or core banking system enabling functionality comprising authentication, transmission, and receipt of data and/or transactions between a plurality of systems, a custodial and non-custodial account management system compatible with smart contracts systems enabling on-chain and/or off-chain transactions comprising buying, selling, transferring, depositing, withdrawing, tokenizing, issuing, and redeeming of fungible assets, wherein said system, wholly or partly, synchronizes off-chain account management system balances via open and/or core banking with on-chain account management systems for facilitating the issuance of CBDCs and stablecoins, conversely, synchronizing on-chain account management systems balances via RPC nodes and APIs, enabling completely or partially, the redemption of CBDCs and stablecoins, smart contracts systems facilitating on-chain and/or off-chain actions and control of on-chain and/or off-chain fungible and non-fungible assets, a messaging system utilizing standardized communication protocols comprising ISO standards for interoperable sending and receiving of messages, (g) RPCs nodes and APIs interfacing with private, consortium, and/or public blockchain systems for the transmission, receipt, reading, and writing of data, and a centralized and/or decentralized storage system for storing, sharing, accessing, retrieving, updating, and synchronizing data.

Also in one embodiment, the account management system is linked to at least one physical or digital identity or payment credential. Also in one embodiment, the near-frequency communication system enables at least two devices embedded or compatible with near-frequency technology to have single or multiplexed communication and data exchange via encrypted and unencrypted protocols. Also in one embodiment, the near-frequency system further comprises a communication module for embedding and integrating NFC specifications for wireless short-range data exchange into NFC-compatible systems.

### BRIEF DESCRIPTION OF THE DRAWING FIGURES

Illustrative, non-limiting exemplary embodiments may be more clearly understood from the following detailed descriptions, particularly when taken in conjunction with the accompanying drawings, in which:

FIG. 1 is a data flow diagram illustrating interoperable banking and payment system according to certain exemplary embodiments of the system.

FIG. 2 is a flow diagram depicting interoperable banking account onboarding and client lifecycle according to certain exemplary embodiments of the system.

FIG. 3 is an organizational diagram depicting interoperable banking, smart contracts, and wallet systems capabilities according to certain exemplary embodiments of the system.

FIG. 4 is a data flow diagram illustrating upstream systems integrated with the system's gateway(s) according to certain exemplary embodiments of the system.

FIG. 5 is a structural diagram illustrating the architecture of the systems gateway and microservice system according to certain exemplary embodiments of the system.

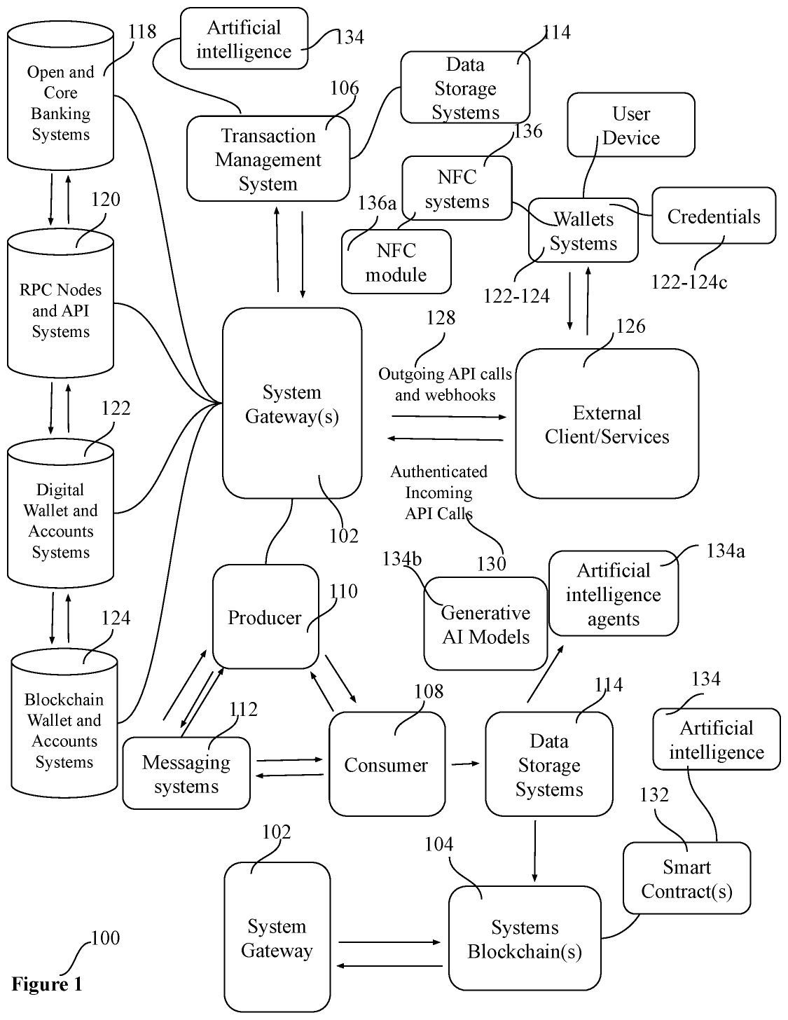

FIG. 1 through 5 may include many of the same components. Those components are unchanged in these certain embodiments retaining their original element numbers and are not reintroduced.

### DETAILED DESCRIPTION

The inventor provides unique and interoperable on-chain and off-chain banking and payment systems that may facilitate and streamline the interaction, issuance, execution, clearing, settlement, and of on-chain and off-chain accounts and assets. Said system may simultaneously streamline and automate compliance and regulatory recording, reporting, and storage in an immutable and trustless way. The following descriptions of certain exemplary embodiments of the systems are not intended to limit the system to these exemplary embodiments, but rather, to enable any person skilled in the art to make and use the systems. The new system may use open and core banking systems, artificial intelligence systems, smart contracts systems, and other derivatives of distributed ledger systems, multi-currency on-chain and off-chain account management systems, microservice middleware systems, orchestration logic, smart routing and transaction optimization systems, and standardized messaging and communication systems.

Referring to FIG. 1—a data flow diagram illustrating open banking and payment systems according to certain exemplary embodiments of the system. Open and/or core banking 118 and blockchain-based systems 120 may enable real-time and historical balances and transactions to be transmitted, received, and queried from bank accounts and blockchains account systems 122-124. And thus, may facilitate the verification of identity, payment, and banking data when communicating with the gateway of the system 102.

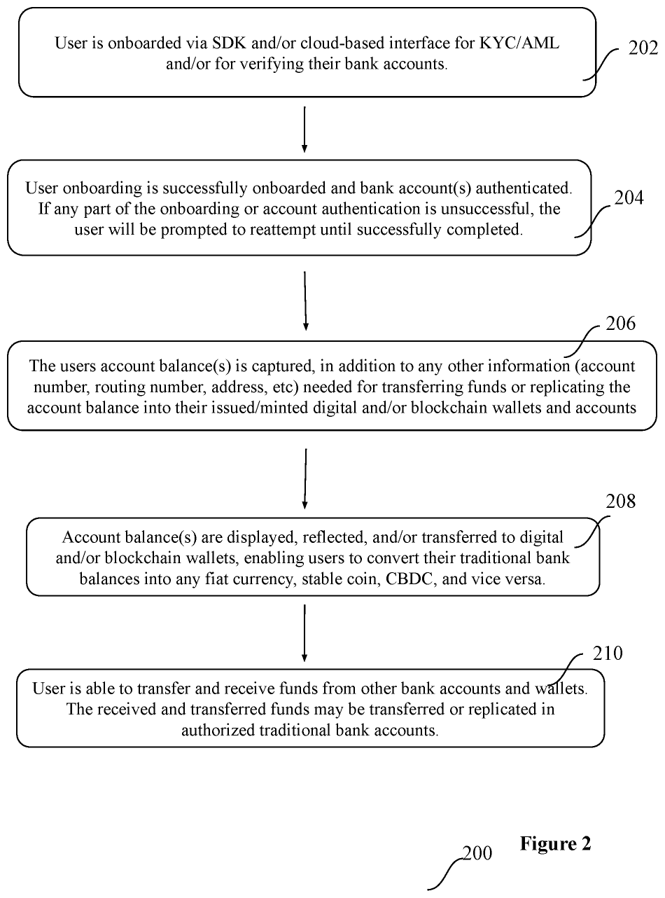

Referring to FIG. 2—a flow diagram depicting account onboarding and transaction lifecycle according to certain exemplary embodiments of the system. One advantage of certain embodiments is a system that may onboard users 202 and enables bank accounts that have been authenticated via open and/or core banking 204 to create preferably multi-currency digital wallets and account and/or blockchain-based wallets and accounts 206 that may synchronize with the authenticated account(s) to facilitate on-chain and off-chain issuance and redemption, and regional, cross-border, and/or multi-chain on-chain or off-chain transactions 208.

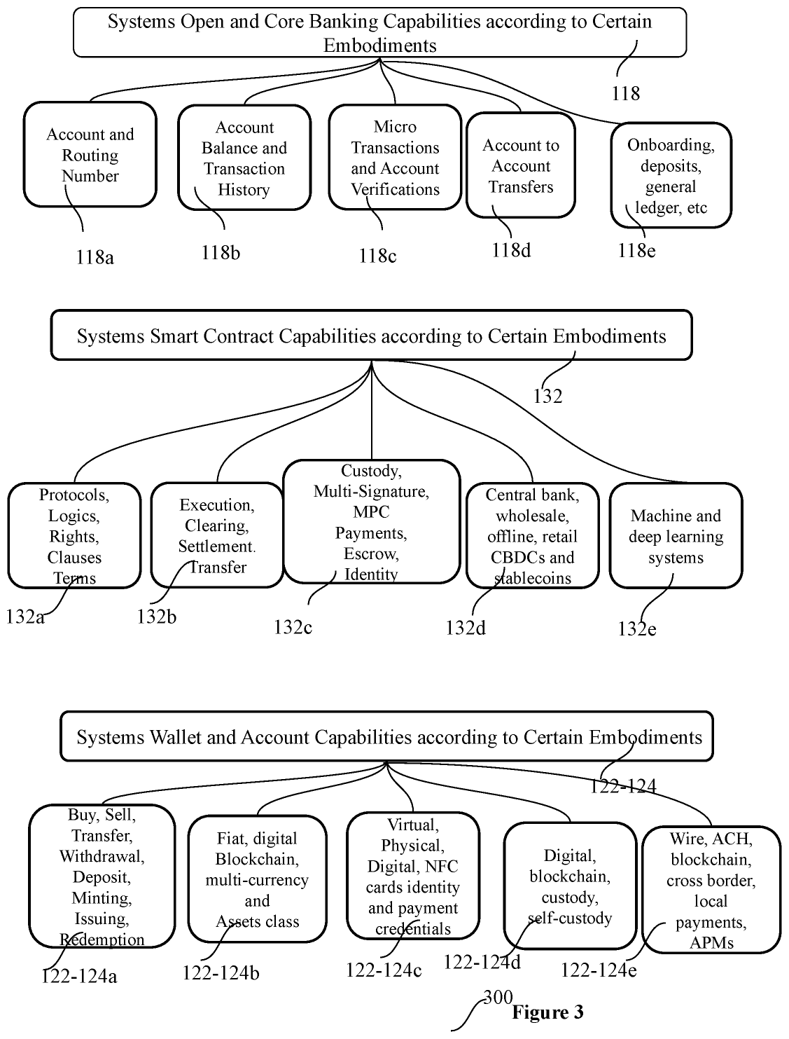

Referring to FIG. 3—an organizational diagram depicting open banking 118, smart contracts 132, and wallet and account system 122-124 capabilities according to certain exemplary embodiments of the system. In certain exemplary embodiments of the system, a wallet and account system 122-124 may create at least one wallet or account 122-124 that may reflect and replicate the balances of the authenticated accounts 118b, receive funds from an authenticated account via methods of transfer 118c, utilize details fetched from an authorized open banking request 118a to fund the account or wallet 122-124 or send and receive funds from an account or wallet 122-124 via A2A open banking capabilities 118d or others methods of payments 122-124e.

Another advantage of certain exemplary embodiments of the system is that wallets and accounts systems 122-124 and/or smart contracts 132 wallets and accounts may utilize artificial intelligence agents 134a to automate the initiation and execution of contracts 132b, control of assets (escrow, multi-signature accounts) 132c, automate the transfer of assets/assets rights (fungible, non-fungible) 132a, and control the transaction lifecycle (execution, clearing, settlement) 132b. Terms, rights, protocols, logic, and clauses of agreements, contracts, assets, and accounts, may be programmed into a single smart contract and/or series of contracts 132a. Allowing at least one (un) known party to transact with or without the need for centralized and/or trusted intermediaries.

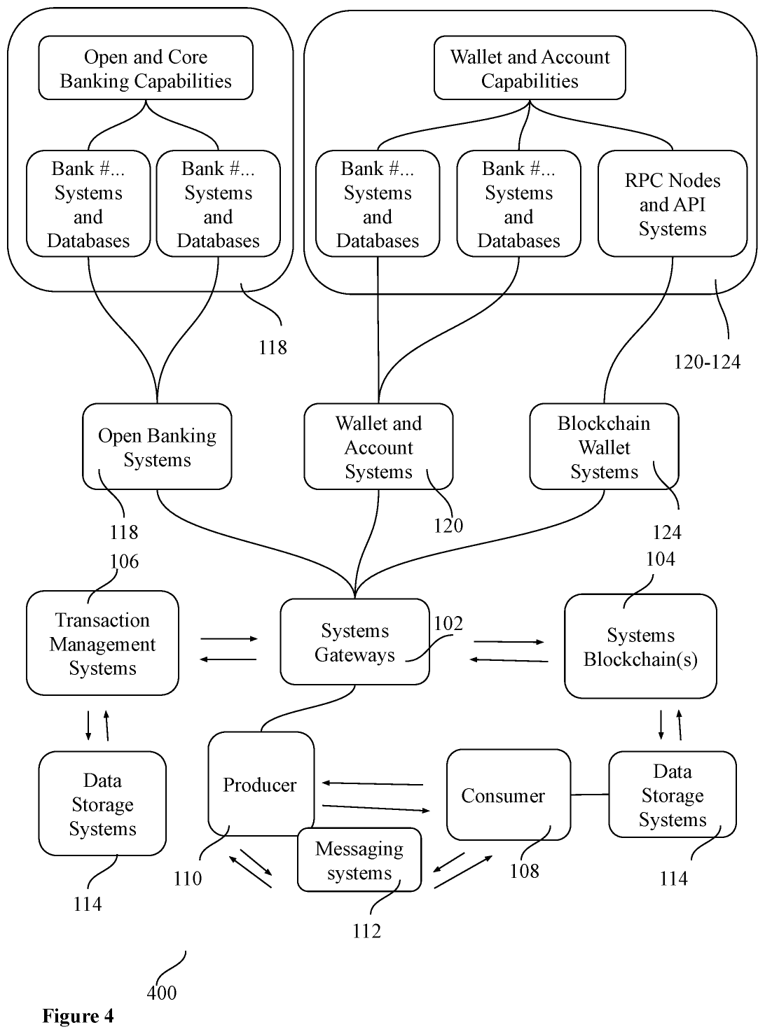

Referring to FIG. 4—a data flow diagram illustrating the systems integrated with the system's gateway(s) 102 according to certain exemplary embodiments of the system. In certain exemplary embodiments of the system, digital and/or blockchain wallet and/or account systems 122-124 may communicate and interact with off-chain open or core banking systems 118 and on-chain blockchain systems 104/120/132 via centralized and/or decentralized APIs request/webhooks 128-130 to facilitate on-chain or off-chain transactions. Messaging brokers 108-110 and engine systems 112 and APIs and webhooks 128-130 interacting with the system may induce smart contracts 132 to initiate and/or execute upon verifying identities, documents, and transactions. Said initiation or execution may seamlessly facilitate the minting, issuance, tokenization and/or transfer 122-124a of fiat, digital, and/or blockchain assets 122-124b via on-chain and off-chain account management systems 122-124.

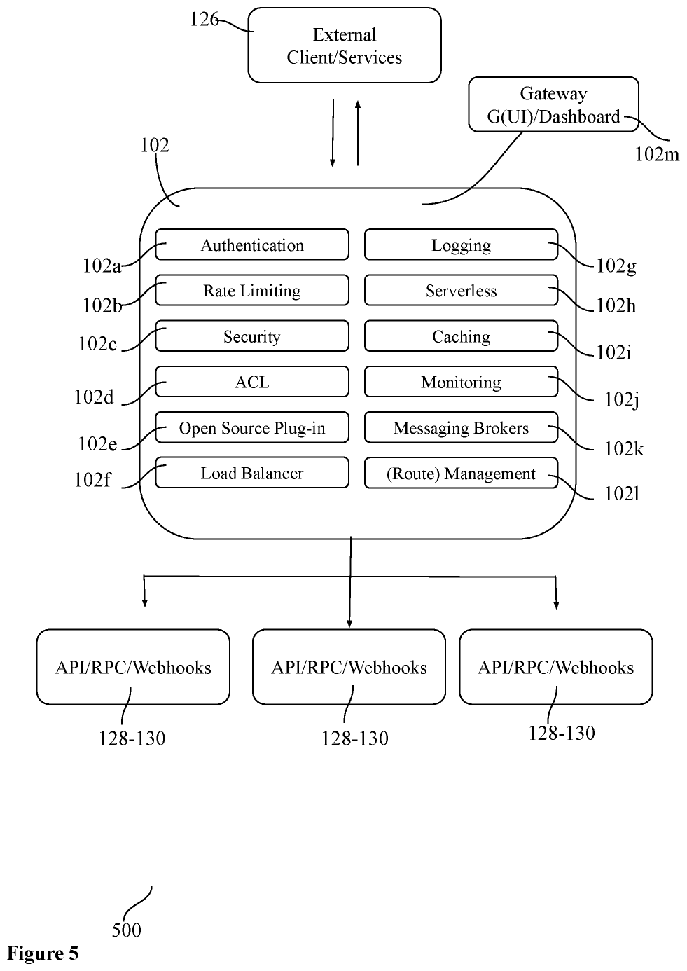

Referring to FIG. 5—a structural diagram illustrating the architecture of systems gateway and microservice systems 102 according to certain exemplary embodiment of the system. In certain exemplary embodiments of the system, the system may leverage microservice middleware systems 102 for actions comprising 102a-1 the accessing, managing, and monitoring of the capabilities, interactions, and throughput of the system. The gateway(s) 102 pluggable architecture may be used for a multitude of functions comprising—tracking API calls, tracking transactions, issuing and sharing API keys, secrets, and credentials, tracking system capacity 102a-1, fetching open banking balances and historical data 118b, fetching exchange rates 122-124b, posting transactions to create user wallets 122-124 and transactions, sending and receiving blockchain data and transactions 120, wire, FX, and local payments 122-124e, signing transactions 120, receiving webhooks 128, onboarding for KYC/AML 118, among others.

A benefit of the system is a gateway 102 and microservice management layers 102a-1 that may utilize objects to wrap properties of a plurality HTTP(s) endpoint to synchronize specific tasks and/or services, wherein configurations may comprise HTTP methods, upstream URLs, endpoint URIs, that may be used for tasks comprising proxying requests, rate limits, timeouts, among others. Endpoints of the system may utilize authentication methods 102a comprising OAuth, JWT, and API keys. In certain exemplary embodiments of the system, APIs of the system and/or APIs that interact with the system may utilize JSON Web Token (JWT) to authenticate other API requests or JWT with OAuth for higher security. APIs may also utilize API keys in their request to authenticate requests with the system.

In certain exemplary embodiments of the systems gateway and microservice management system 102, is a cloud (centralized and/or decentralized) and/or on-premise-based gateway, wherein said gateway may serve as a reverse proxy enabling the managing, configuring, and routing of API requests. The systems gateway and microservice systems 102 may utilize a plurality decentralized and/or distributed architectures including but not limited to hybrid cloud, or multi-cloud deployments. The modular nature of the gateway of the system 102 may enable workflow automation by utilizing a plurality of plugins, APIs, applications, upstream services 118-124.

Objects of exemplary embodiments of the microservice middleware system 102 may be utilized to direct or wrap properties and capabilities of any open and core banking systems 118, on-chain wallet and account systems 122, RPC Nodes 120, blockchain wallets 124, etc to the systems API sandbox (testnet) and production (mainnet) endpoints, wherein tracking 102g/i/k, and access control 102 a/b/c may be implemented. Incoming requests 130 may be load-balanced 102f and/or proxied 102 and may function in conjunction with a virtual host and/or serverless systems. A (G) UI 102m may be used for visualization of network and system configurations, endpoints, and performance, among others 102a-1.

The data storage systems 114 utilized by the gateway 102 may support, interact, and store data with SQL and/or no-SQL-related databases. Data storage systems 114 may contain fixed or variable schemas to define how data is stored and categorized by the systems. A benefit of certain exemplary embodiments of the system is a microservice middleware system 102 that can handle significant numbers (i.e., billions) of transactions per second (tps) as system nodes may automatically distribute and scaling demand, as gateway 102 processing accelerates.

In certain exemplary embodiments of the system, to manage and automate compliance screening, monitoring and reporting tied to gateway and microservice system 102, the system may utilizing AI agents 134a and generative ai models 134b to automate the filing of Suspicious Activity Reports (SARs) and Counter Terrorism Reports (CTR) with FinCEN and other regulators via systems like GoAML, in the proper format—XML, etc. The system may auto-fill parts of the SAR, CTR, Travel Rule forms by leveraging information extracted when an account is authenticated via an open and/or core banking systems—first and last name, account and routing number, address, DOB, and address, among KYC/B processes. In addition to providing (meta) data of transactions processed via microservice middleware system 102, KYC/AML information may also be captured by (enhanced) due diligence capabilities of the system 100 or via 3rd party onboarding systems.

In certain exemplary embodiments of the system, a transaction management system 106 may be synchronized to monitor, screen, track, report, and learn from (meta) data processed 108-114 through the gateway 102. (Meta) data may comprise transaction value, frequency, type, risk, location, currency, wallet type, asset type, messaging protocol, error messages, notifications, time/day, unique identifiers, and other data related to the system 102. (Meta) data processed by the system's gateway 102 may be aggregated, stored, trained, and classified into likely or unlikely groups and categories that may be automatically or pre-derived by the system 102 or users of the system 126.

A benefit of certain exemplary embodiments of the system is a gateway 102 that may interact with, and/or serve as a transaction management system 106. Said transaction management system 106 may ingest data to train (remotely, cloud) models of machine and/or artificial intelligence 134 in intervals and/or continuously. Allowing the system to learn processes and functions pertaining to anti-money laundering, transaction screening and monitoring, fraud detection/prevention, transaction optimization, and anomaly detection. Data consumed by the transaction management system may be ingested in a plurality of ways, comprising but not limited to API, FTP, and messaging brokers 108-110. Furthermore, data aggregated 114 by the system may be overlaid with 3rd party and/or external data sources to enhance the efficacy and reliability of machine and/or deep-learning 134 systems of present disclosure.

In certain exemplary embodiments of the transaction management system 106, a data pipeline may ingest and transfer (meta) data via API(s) and/or messaging broker(s) 108-110 and. The messaging brokers 108-110 leveraged by certain embodiments of the system may allow the gateway(s) 102 to stream information in a WebSocket and/or continuously for high transaction throughput. The messaging broker(s) 108-110 may contain at least one producer 110 (sender of messages) and consumer 108 (receiver of messages). The system, once data is received by the consumer(s) 108—may parse data via logic and/or algorithms of the system, before storing the (meta) data in distributed and centralized databases, 3rd party systems, and/or the blockchain(s) utilized by the system. Data received by the consumer 108 may be received and stored by schema(s) and topic(s) that may be linked to one or more feeds and/or topics for routing data from producer(s) 110 to the consumer(s) 108.

The systems producer(s) 110 may communicate with the gateway and microservice systems 102 and/or transaction management system 106, by pushing data to the consumer 108, transaction management system 106, or messaging systems 112. Similarly, the producer 110 and consumer 108 may communicate with data storage systems 114 to reconcile transactions, wherein in-memory data structure storage may be distributed, allowing for the utilization of in-memory key-value databases, cache, and message broker(s) 108-110. Certain embodiments of the system may support a plurality of abstract data structures, comprising strings, lists, maps, sets, sorted sets, bitmaps, streams, and spatial indices. An advantage of certain exemplary embodiments of the system is a consumer 108 that may listen on a topic or feed for data to be sent from the producer 110 that is synchronized with the gateway 102 of the system. The producer 110, consumer 108, and data structure servers may be hosted on the same or separate server as the gateway 102.

Due to the system's capability to process high transaction throughput, in certain exemplary embodiments of the system, at least one messaging system 112 and similar mechanisms for responding to a system request to perform tasks may be used to reconcile network transactions—i.e., transactions missed (not received) by the consumer 108, or not streamed, pushed, and/or sent by the producer 110. The messaging system(s) 112 may listen for transactions coming through the system's access points—i.e., alerting the producer 110 that certain information was not successfully received by the consumer 108 by querying and/or listening to in-memory data storage systems 114 synchronized with the processing endpoints of the system, thus enabling the producer 110 to resend any missing data to the consumer 108 for further processing and/or storage. The present disclosure may utilize a conversion function (algorithm) to transform data into a plurality form of machine-readable and/or human-readable formats transmitting the data via the messaging brokers 108-110 or APIs of the system. In certain exemplary embodiments, wherein NoSQL database(s) 114 are preferably being utilized, data transmitted may be replicated across multiple databases in a distributed manner for replication, redundancy, etc.

Expanding on certain exemplary embodiments of the system, parties may transmit instructions via messaging systems 112 and protocols compatible with the system of disclosure. Instructions communicated may be structured by message types and fields, enabling standardization and uniformity of input and output messages being transmitted via encrypted protocols. Messages transmitted may be matched to similar offsetting transactions, causing the execution of smart contracts 132, funding, transferring, and creating a binding arrangement between the counterparties, for off-chain transactions.

To initiate the on-chain recording of the off-chain settlement, financial communication protocols may be used to communicate the data needed to settle a transaction off-chain to depository institutions/transfer agents' messaging systems 112. In certain exemplary embodiments, the sending of the said message may trigger the initiation of the settlement programmable contract. Messages received from depository institutions may be received by the systems messaging systems 112 with the settlement smart contract 132 executing post-receipt of settlement-related messages or at the settlement date specified. A benefit of certain embodiments of the system is a system enabling execution, clearing, and settlement to happen off-chain via account and/or digital wallets 122, but reporting, recording, and storage of transaction hash data happen on-chain with transaction history being confirmed via open banking and/or digital wallet balances utilizing transaction history API calls, webhooks, etc.

In certain exemplary embodiments of the system, on-chain transaction hashes may be present, with off-chain information linked to transaction hashes viewable by clearing or depository institutions, eliminating the need to report execution, clearing, and settlement-related activities to external facilities via the messaging systems. On-chain and off-chain data may be viewable to reporting facilities, clearing agencies, and depository institutions in a trustless manner. Terms, logic, and algorithms, consistent with regulatory and compliance expectations may be programmed into the smart contracts 132, eliminating the need for parties to report or reconcile transactions. The smart contracts 132 may be responsible for reporting, recording, and the transfer of digitized assets as assets may be controlled by smart contracts 132. A benefit of certain exemplary embodiments of the system may include the logic of (financial) messaging, protocols, etc that may be embedded directly into smart contracts 132—enabling the execution, clearing, and settlement of smart contracts 132 to occur dynamically.

In certain exemplary embodiments of the system, assets tied to connected accounts and/or digital wallets 122 may be issued, digitized, and/or tokenized on-chain. Counterparties may send instructions to on-chain or off-chain accounts and/or wallets 122. The logic of information transmitted via financial communication engine protocol may be structured within the smart contract 132 by message types, and fields, enabling standardization and uniformity of input and output messages being transmitted. The system's smart contracts 132 may serve as wallets 124, controlling assets, keys, permissions, etc. For example—post order is routed and executed, the clearing and/or settlement contract may be triggered, and assets unlocked, transferred, and settled.

Certain exemplary embodiments of the system may utilize more than messaging systems 112 protocol to facilitate communication for execution, clearing, and settlement purposes. Communication between parties may happen via encrypted communication channels—i.e., session-based Transmission Control Protocol (TCP) that may carry financial transaction data securely between distributed messaging systems 112. In certain exemplary embodiments, to establish a unique connection with the system, transacting parties may log on, creating a secure session with the system's messaging systems 112. Sessions may be composed of one or more connections or sessions spanning multiple and continuous message exchanges. Messages may be classified as administrative messages or application messages. Administrative messages comprise message types that establish and close a connection and application messages consist of a plurality execution, clearing, and settlement messaging types.

Certain exemplary embodiments of the messaging systems 112 may support multiple messaging protocols simultaneously and multiple sessions simultaneously. Messages of the protocols may be configured to support a plurality of asset classes including cash, equities, fixed income, derivatives, and foreign exchange, among others. Messages may come with predefined messages and tags and also support user-defined messages and types. The systems communication systems may be multi-threaded architecture providing the ability to interpret specific dialects, interpretations, and versions, and the said engine may be synchronously and asynchronously persistent.

In certain exemplary embodiments, adaptors for streaming information may be present, wherein binary compression algorithms may be utilized to optimize bandwidth and latency requirements in the dissemination of real-time data in high volumes. The message forming of market data streaming protocols may disseminate information in customized formats and structures—i.e., machine-readable XML-based formatting and other forms of machine/human-readable format. Data messages may be compact utilizing implicit tagging, wherein order fields within the message are fixed, enabling messages to be transmitted and deciphered without field tags describing the values.

In embodiments of certain exemplary implementations of the system, message parsers may be used independently or integrated with the system. Message parsers may consume or generate messages, interpret incoming messages, check the syntax of messages, and create a structured reaction to messages. Outgoing messages may be created and validated enabling parsing and messaging sending and receiving messages between distributed systems. A benefit of the embodiment of the messaging systems 112 is financial messaging protocols that may enable firms to transact in a standardized manner to enable minimal message interpretation issues.

In certain exemplary embodiments, the financial messaging system may utilize simple binary encoding (SBE) for decoding and encoding messages in binary formatting, allowing for lower latency and the deterministic transmission of messages. Message formats may be defined using primitive data types, eliminating the need for translating data into a wire format. A benefit of an embodiment of the embodiments is systems that may address data creation solely with fixed and variable length fixed supported. Message layouts may be defined in XML-based schema, said schema (templates) may define which fields belong to a message and said fields' position within a message. The system's SBE may provide a compiler for taking a message schema and generating stubs for messaging parsing in multiple languages and enable real-time decoding of messages from a compiler-generated meta description.

A benefit of certain embodiments of the system is a transaction management system 106 capable of detecting different typologies and mitigating false positives during the transaction monitoring and screening process. The system may use supervised and/or unsupervised artificial intelligence 134 to better identify false positives. Another benefit is a transaction management system 106 capable of positively identifying known money laundering typologies including but not limited to fan-out (single sender and multiple receiver accounts), fan-in (multiple senders and single receiver accounts), scatter-gather (main account distributes money to several members and members send most of the received money to a single account), stacked bipartite, bipartite, etc. via machine intelligence 134. The system may also identify unknown patterns via unsupervised machine learning 134.

In certain exemplary embodiments of the present disclosure, vendor agnostic open and core banking systems 118 may communicating with the systems gateway 102. The system may utilize GET data requests from a single open and core banking source, multiple open and core banking sources, and/or an open and core banking oracle (aggregating data from multiple open banking systems), to provide the owner account details, real-time account balances 118b, routing and account numbers 118a, and A2A transfer capabilities 118d that may be utilized for funding, verification, and compliance, creating wallets and accounts 122-124 that may be synchronized with the connected account(s) 118 for creation of fungible on-chain assets.

The geographical and vendor-agnostic system may enable any open and core banking solution and wallet and/or account 122-124 systems to seamlessly integrate within the gateway of the system 102 using APIs. An advantage of the system is a system that may enable APIs calls 118-124 by upstream partners to be standardized or non-standardized—i.e., endpoints are called the same for all upstream integrations regardless of the underlying request structure or according the request structure. Logic and algorithms may be used to create and route specific requests upstream to a plurality of upstream APIs to accommodate their structure and enable their APIs to be called from the gateway 102, as is.

A benefit of certain exemplary embodiments of the system is distributed microservice middleware system 102 that provide seamless access integrations to downstream participants of the system. The gateways 102 of the system may serve as a proxy 128-130 for accessing the system open and core banking 118, multi-currency digital wallet and accounts 122, etc., and may provide unified access and integration via the gateway 102 for actions comprising, the querying real-time account balances 118b, creating of wallets and accounts 122-124d, initiating transactions, onboarding, among other processes. By utilizing an gateway microservice architecture, in a plurality of exemplary embodiments, the system may integrated with any account management system 122, open and core banking connection 118, blockchain wallet and account system 124, and other upstream systems to provide interoperability, optionality, redundancy, persistence, and greater liquidity and geographic reach to downstream clients.

Similarly, an advantage of certain exemplary embodiments of the system is the open and core banking 118 redundancy. Thus, limiting the risk of erroneous transactions based on inaccurate data from using a single open banking source. The system may verify account information across multiple open and core banking systems 118. Utilizing each connection and access 118, to verify balances and transactions history before transacting, among other things. For example, to manage risk—if a transaction is over a certain threshold—i.e., $100,000, the system may require at least two open banking systems to verify an account balance 118b before funding accounts or issuing onchain assets 122-124.

In certain exemplary embodiments of the system, the system-utilizing at least one open or core banking source 118 to fetch banking data, may facilitate the real-time querying of account balances and data 118, before minting (issuing) 122-124a a wallet 122-124 (in the event it is a new wallet), initiating the funding of an existing wallet or account 122-124, or initiating a on-chain or off-chain financial transaction (in the event of an existing wallet that is funded) via the account management systems 122-124. A benefit of the system is that the on-chain (blockchain data) and off-chain (open/core banking) account balance and history 118b of transacting parties may be known to all counterparties in real-time, to ensure that only amounts authorized may be transacted. A key advantage of this is mitigating clearing risk to accelerate the clearing and settlement of on-chain and off-chain transactions.

An advantage of certain exemplary embodiments of the system is that any banking and payments system may serve as an upstream system integrating with the microservice middleware system 102 via APIs or messaging systems 112 or brokerages 108-110, thus facilitating optionality and interoperable communication for network participants to facilitate on-chain or off-chain transactions, globally. Other benefits may include greater network liquidity, cross-border corridor payment reach, and wallet 122-124 infrastructure redundancy. The system may enable at least one verified bank account 118c, to have at least one account and/or wallet 122-124 to facilitate on-chain or off-chain financial transactions. Transforming an off-chain bank account in a single underlying currency into a multi-currency on-chain or off-chain wallet or account 122-124.

An additional benefit of certain exemplary embodiments of the system is the ability of the system to generate fees from a plurality of transaction and system activities. The system may utilize on-chain or off-chain invoicing, billing, and collection systems, wherein the system may monetize on transactions a plurality of open and core banking connections, digital and/or blockchain accounts and wallets 122-124, foreign exchange, transaction volume, among others. Moreover, the system may leverage a plurality of algorithms and logic to smart route transactions based on liquidity, pricing, settlement time, and maximum/minimum fees among other things.

Certain exemplary embodiments of the system may utilize a buy-rate model for invoicing and billing calculations, enabling transaction and volume rates provided by upstream systems to be marked up—i.e., 15 basis points (bps) rate from the integration and the system adds 15 bps for 30 bps final price downstream. As such, systems integrating within the gateway and microservice system 102 may provide a base fee manually, semi-programmatically, and/or programmatically that the system may manually, semi-automatically, and/or automatically mark up. Another value proposition of certain embodiments of the systems is the ability to automate onboarding and placement with upstream partners, as individuals and businesses utilizing the gateway 102 may be allocated to integrations that meet their underlying risk/compliance tolerance, technical, and product needs.

In addition to optimizing for cost, settlement time, and other considerations unique to each upstream system within the gateway 102, in certain embodiments of the disclosure—a the system may facilitate the real-time on-chain and/or off-chain execution, clearing, and settlement of transactions via the gateway 102, messaging systems 112, or account management systems 122-124 compatible with the gateway 102 and messaging systems 112, without the system needing to hold or custody assets directly or operate, as gateway integrations may assume custody when executing, clearing, and settling transactions.

The wallets and accounts 122 systems may be multi-currency accounts or wallets 122, that may preferably have a virtual, physical, or digital identity and/or payment card 122-124c, once at least one account has been authenticated via open or core banking. Authentication may comprise correctly validating the credentials (password, username, OTP, biometrics, etc.) tied to an underlying account. Enabling integrations of/or utilized by the system to automatically create on-chain or wallets and accounts 122 once an account has been authenticated and when additionally prompted or predetermined, create an off-chain wallet(s) 124 simultaneously, or thereafter.

In certain exemplary embodiments of the system, a system for implementing NFC specifications and communication systems for wireless short-range data exchange may be leveraged 136a, which may enable NFC systems 136 and tags to be embedded. NFC systems 136 compatible with the system may have antennas that serve as inductive power receivers for communicators, wherein energy is provided by the NFC reader 136 as needed, without limitation. NFC systems 126 may be embedded in plastic, paper or any other compatible material or systems. Enabling persistent memory, as memory may utilize standardized formats and commands for storing NFC data in formats comprising NFC Data Exchange Format (NDEF).

In certain embodiments, the NFC systems 136 may have specific commands per application. While in other exemplary embodiments, NFC communication for embedded devices may utilize microcontrollers of the embedded device for information exchange. Expanding on exemplary embodiments of the system, logical link control protocols may be used for allowing multiplexed communication between at least two NFC systems 136. Service access points may serve as transfer mechanisms, enabling at least one peer to send protocol data units at any time—asynchronously. In certain exemplary embodiments, the service access point may be split into at least two parts. Each service access point address may convey a plurality of insights into the communicating devices.

In certain exemplary embodiments of the system, simple NDEF exchange protocols may be used to enable two NFC systems 136 to exchange NDEF messages. The NFC protocols compatible with the system may be stateless request/response-driven protocols. The client may send a request to a server, and the server may process aid requests and return a response. A benefit of certain protocols and messages communicated the system is the ability to communicate maximum information units supported by a data link connect that is established between client and server.

The wallet 124 and non-fungible identities 122-124c utilized by certain exemplary embodiments of the disclosure may be linked with wallet 122 or physical cards 122-124c to enable transactions and onboarding in-person, online, or in the metaverse. Contingent on certain exemplary embodiment, cards may be linked to the portable ID 122-124c by QR code and/or NFC technology 136, serving as a payment and/or identity transmission system whenever the QR code or NFC card, tag, etc. 136 is exposed. In certain exemplary embodiments, the wallet 122-124 of the system may have an NFC and QR reader/transmitter 136 that may enable seamless onboarding and payments with compatible devices. Linking said payments to the portable ID 122c by saving transaction details to a centralized or decentralized storage system 114 or blockchain 104. Payments transmitted via the wallet 122-124 and/or portable ID 122-124c linked NFC card 122-124 may be facilitate on-chain and/or off-chain transactions. In certain exemplary embodiments, the cards 122-124c may be linked to the portable identity onchain 132c by QR or NFC off-chain. In certain exemplary embodiments, the wallet of the system may have an NFC reader 136.

The wallets and accounts systems 122 of the exemplary concepts may funded via traditional (off-chain) or blockchain (on-chain) means of transfer (ACH, Wire, Debit Card, Open Banking A2A transfer, stablecoin, etc.), or by mirroring the balance of a synchronized and authenticated account in the account and wallet systems 122-124 balance and by leveraging open banking APIs 118 of the disclosure. The wallet and account system 122 may reflect the same, greater, or lesser balance than the connected account. Subsequently updating the account management system 122, blockchain 104, and/or connected account balance 118 for executed and/or pending on-chain and off-chain transactions via methods like API calls or webhooks.

In certain exemplary embodiments, the system may utilize the account and routing number data fetched from an open or core banking connection, as the basis for enabling funding or issuing of on-chain or off-chain assets in the wallet and account system 122. The wallets and accounts system 122 may facilitate the pay-in, payout, and foreign exchange conversion in any on-chain or off-chain currency. Moreover, the wallet and account system 122 may enable the exchange of any fiat or digital currency before facilitating (cross-border) financial transactions.

In certain exemplary embodiments, RPC APIs 120 that fetch blockchain balances may be used for capturing the balance of wallets 124 and signing transactions, so that funds may be used for facilitating wallets and/or account systems 122-124 for (cross border) financial transactions. A benefit of the system is a system that may convert crypto to fiat via OTC, exchange integrations, swapping systems, and/or other on-off ramps for crypto to fiat via API integrations. As a result, the system gateway 102 may utilize blockchain-based APIs for funding and account balance verification, in much the same way that open banking API of/utilized by the system may be used for real-time fiat balance verifications, transaction history, and account-to-account funding, identity verification, among others.

In certain exemplary embodiments of the system, the blockchain-based wallet and account systems 124 of and/or interacting with the system may be custodial and/or non-custodial 122d. Said wallet synchronizing and communicating with authenticated bank accounts 118, tokenizing and/or digitizing the fiat balance on any blockchain for issuance and/or minting the blockchain-based currencies selected. Said balances of systems on-chain wallets 124 may also reflect the underlying balance (or percentage of the balance) of the verified account(s) 122.

The wallets and/or account systems and accounts 122-124 of certain exemplary embodiments may communicate with distributed ledger systems (blockchain) 104, that may support programmable (smart) contracts 132, that may facilitate and automate transactions, transfers of rights, and issuance/minting of assets. The distributed ledgers (blockchains) 104 capable of interacting with certain exemplary embodiments of the disclosure, may be private, consortium, and/or public in nature. Access may be permissioned and/or permissionless-nodes and consensus of blockchain networks may be controlled by a single entity, group of approved entities, or the public. Another benefit of certain exemplary embodiments of the system is a blockchain system enabling participants of the network to read, write, and audit blockchain data based on permission levels to maintain transacting parties' anonymity.

In certain exemplary embodiments, the systems may utilize a native blockchain 104, decentralized cloud 114. Thus, providing multiple layers for the minting of assets and storing of data based on specified parameters and configurations of network participants, to ensure the necessary security, privacy, and scalability. Anonymized open and core banking data and a plurality of personal and transaction data may be stored on-chain 104 and/or in decentralized clouds 114 utilizing non-fungible tokens 102 or other decentralized verifiable credentials 122-124c for authentication. Helping to provide transparency into the real-time identity and account balances in a persistent, trustless, and decentralized way.

In certain exemplary embodiments of the system, the system may be blockchain agnostic, allowing the reusable identity 122-124c to be linked to at least one identity and at least one wallet and account 122-124, irrespective of the underlying chain of the non-fungible token 132 and the wallets 124 being linked to the ID 124c. In certain exemplary embodiments, the smart contracts 132 utilized by the system may run on a native blockchain 104. In certain exemplary embodiments, smart contracts 132 may run on a native blockchain 104 and another layer 1 or layer 2 blockchains 104. To validate transactions within the network, a group of predetermined or authorized nodes (computers, laptops, servers) may be observed. In certain exemplary embodiments, to maintain anonymity for users of the present disclosure, only predefined nodes may be able to view the total aggregated content of the blockchain. Data may be distributed among nodes of the network creating an immutable audit trail.

Certain exemplary embodiments of the system may leverage derivatives of distributed ledger technology 104 for transparent execution, clearing, and settlement of transactions, and storing of transaction (meta) data. Providing persistent audit trails for transactions, and preferably immutable (meta) data that may facilitate the (semi) automatic reporting of a plurality of transactions—i.e., compliance—suspicious activity report (SAR) and counter-terrorism financing (CTF).

In certain exemplary embodiments 104, users may have the option to run different types of nodes (master, full, light). A master node may have multiple functions within the system of the present disclosure, including but not limited to validating transactions, creating new blocks, managing voting events, governance, and providing execution of protocol operations, among others. Master nodes may be online 24/7, as a result, they require more maintenance, storage space, and memory. To run a node(s), an entity may be required to deposit a minimum amount of fiat, digital, virtual, and cryptocurrency as collateral. Collateral may be seized in the event a node violates the rules of the blockchain. Entities of the system may run full nodes or light nodes. Full nodes contain a full copy of the blockchain's 120 transaction history, while light nodes may contain a segment or portion of the blockchain's 120 transaction history.

Once validated, data may be grouped into blocks and stored on chain 104. Nodes of the system may be connected and constantly exchange the most recent blockchain data, ensuring all nodes stay up to date. Once a validator (master) node accepts a new block of transactions, it is added to the existing blocks. Nodes can be online or offline. Online nodes (typically master and full nodes) receive, save, and broadcast the latest blocks of transactions to other online nodes. When an offline node comes online, it may download all blocks that were added to the blockchain 104 since the node went offline to synchronize with the other nodes.

The sequential linking of blocks within the system's blockchain(s) 104 ensures immutability and the information contained therein. For each entity running a node of the ecosystem, a copy or partial copy of all transactions may be readily available. Private smart contracts 132 may enable data to be encrypted ensuring anonymity for users, wherein participants may only view metadata pertaining to the said participant. Entities may control access to ledger data at a department, function, regulator, employee, and user permission level. Ensuring a variety of end-users access to a single source of truth. Each transaction recorded and stored within blocks on the blockchain may be time-stamped, creating an immutable trail for entities of the network to monitor, account for, and extract historical information from the distributed ledger through a variety of compliance reporting-related queries. Preferably disseminated geographically, nodes of the system run a copy of the network blocks (transactions), creating highly secure, transparent, and dependable record-keeping.

Owner account information may be hashed to protect the anonymity of the transacting entity and facilitate seamless transactions by re-utilizing onboarding information throughout the lifecycle of the transaction. For example, an entity may decrypt certain personally identifiable information linked to the non-fungible token 132, decentralized identity, or verifiable credential 124c, that may authenticate themselves in a zero-knowledge manner to facilitate some type of transaction—i.e., wallet creation, funding, transfer, etc., without exposing the underlying (meta) data.

In certain exemplary embodiments, an information hash may be recreated providing attestation to the underlying variables behind the verified hash. In certain exemplary embodiments of the system, once KYC/AML and onboarding have occurred, system participants may remain anonymous, leveraging on-chain cryptographic mechanisms like stealth addresses, mixing, and ring signatures. To protect on-chain and/or off-chain KYC/AML data, cryptographic tools like zero-knowledge proofs, zk-SNARKS, and Pedersen commitments may be leveraged. Off-chain privacy layers like trusted execution environments (TEEs) may also be.

In certain exemplary embodiments of the system, fiat, digital, tokenized currency held in an on-chain and off-chain wallets system 122-124 may be initiated, triggered, and executed, based on internal and external triggers or events. wallets and/or account systems 122-124 of the system may be initiated, triggered, and executed, based on prior/pre-existing actions, current actions, and anticipated actions—i.e., “schedulers”. In certain exemplary embodiments, a government and/or central bank may implement and issue CBDC(s) using existing banking infrastructure, by synchronizing users' existing bank accounts via open and core banking 118 with blockchain-based wallets 124 that may mint, issue, receive, and redeem CBDCs. A benefit of the system is the seamlessly integration of stablecoins and CBDCs may have with the current financial system via open and core banking 118, while simultaneously tying wallets 124 to verified identities and/or accounts 124c.

In certain exemplary embodiments of the system, smart contracts 132 may communicate with accounts management systems 122-124, fulfilling tasks related to on-chain and off-chain executing, clearing, settling, and reporting transactions between the counterparties. Communication may be synchronized via messaging systems 112 and protocols like ISO wherein reporting, recording, and storage of transactions on-chain and off-chain. Furthermore, smart contracts 132 of the system may be compatible with messaging systems 112 to initiate and execute transactions. Creating an environment where a blockchain network may communicate with internal 122 and external messaging systems.

A benefit of certain exemplary embodiments of the system is a messaging system (112) that may standardize communication and messaging utilizing standardized protocols like ISO 20022. The gateway 102 of the system may receive buy, sell, transfer, withdraw, and deposit transactions via API requests tied to the system and/or 3rd party banking and payment APIs 122, utilizing standardize messaging for interoperability with messaging protocols like ISO 20022. This may enable upstream and downstream communication via the gateway 102 to communicate with execution, clearing, and settlement between parties within the traditional (off-chain) and/or blockchain (on-chain) financial system—i.e., central banks and/or banks may utilize ISO 20022 to communicate with blockchain and/or traditional accounts 122-124 that have issued or redeemed CBDCs or stablecoins.

In certain exemplary embodiments of the disclosure, smart contracts 132 may represent or control tangible and intangible assets and a plurality of contractual obligations to exchange assets and asset rights. Traditional assets may be digitized, minted, tokenized via smart contracts 132 on the blockchain 104 to facilitate the exchange of assets and rights. To enforce binding terms on digitized assets, the same and/or additional smart contracts 132 may be used for the execution, clearing, and settlement of on-chain assets. Smart contracts 132 may be used to initiate and execute binding transfers of assets that are not on-chain but instead record and report the data related to off-chain transactions, on-chain. In other exemplary embodiments, the transfer of the funds may take place via on-chain wallets 124 and/or methods of payments 124e. A benefit of certain embodiments is an account management system 122-124 that may support the execution, clearing, and settlement of traditional and digital/traditional (off-chain) and blockchain assets (on-chain).

In certain exemplary embodiments of the disclosure, wallets 124 and/or smart contracts 132 may be used to control and custody assets that are tokenized and/or minted on the blockchain, and those held in traditional fiat-based accounts—even if the said accounts are digitized. This may enable the system to programmatically facilitate the on-chain transfer of security assets, and a subsequent subtraction/addition of off-chain assets to settle financial transactions—and vice versa. The wallets 122-124 may have payment functions (sending/receiving payments, paying fees, receiving rebates), trading functions (interacting with smart contracts 132, order matching engine, messaging system), and clearing/custody functions (margining, escrow, multi-signature, multi-party computation), among other things. Said wallets 122-124 may also be structured as a programmable contract.

In certain exemplary embodiments of the system, a single smart contract 132 may be used to handle the execution, clearing, and settlement functionality and capabilities. In an example of certain exemplary embodiments, the beneficiary, and the recipient are matched to transact, and a single smart contract 132 would be initiated. Once the requisite messages are transmitted and received during the execution, clearing, and settlement phases. The contract's execution may occur at the end of the transaction cycle wherein assets/rights are transferred. A benefit of an embodiment of the system is smart contracts 132 that may handle any one of the three trading functions (execution, clearing, settlement) in single or multiple smart contracts 132 depending on a certain embodiment of the disclosure. The system is dynamic and may handle clearing and settlement functions but not execution, handling execution and clearing but not settlement, among other iterations.

In certain exemplary embodiments of the system, a smart contract 132 may be initiated before and/or after a successful transaction—whether said transaction is on-chain and/or off-chain. The smart contracts 132 may start in an open and/or closed state when transactions are initially routed. Instructions transmitted via financial messaging protocols—i.e., ISO 22022, may be actionable and eligible for execution until canceled, altered, or executed. Transactions may be signed orders and subsequently broadcasted to the gateway 102 to be executed per the transaction instructions and/or systems preferences.

In certain exemplary embodiments, the (gateways of) system may send execution reports and responses back via messaging protocols, engines, and/or webhooks between transacting parties, enabling them to understand the (real-time) status of orders and to communicate with the systems. Execution messages may enable users to confirm the receipt of funds, confirm changes to an existing order, relay order status information from the system, relay fill information on working orders, reject orders, cancel orders, and check the fee calculations associated with transactions, among other things. The messaging system may also send orders and receive execution reports. An advantage of the system is a system that may route orders to external venues via encrypted messaging systems 112 and protocols to fill network liquidity.

Expanding on certain embodiments of the disclosure—once digital and/or blockchain wallet and/or account 122-124 transactions are routed and/or executed—a smart contract 132 may be initiated and/or executed associated with said transaction. The system may preferably save a hash of the transaction information on-chain while storing sensitive information tied to the transaction off-chain. Off-chain (meta) data may be used to recreate transaction hashes on-chain to ensure data storage integrity. A benefit of certain exemplary embodiments of the system is smart contracts 132 that may enable the storing of execution information on the blockchain. Information transmitted to and from certain embodiments of the disclosures smart contract 132 includes but is not limited to the message type, order ID, execution instructions, order quantity, order type, order capacity, side of transactions, currency symbol, and time in force.

In certain exemplary embodiments of the system, smart contracts 132 may be initiated or executed by receiving messages communication protocols and engines transmitted from internal 112 or external messaging systems, that may be whitelisted with the (gateway of the) system. Said messages may contain information details of transactions, allowing data of off-chain and external venue transactions to be stored on a blockchain. Similarly, hashed transactions may be saved on-chain, and transaction information may be stored off-chain. An advantage of certain exemplary embodiments is a system that may validate transaction hashes for data integrity, and regulatory purposes by recreating on-chain transaction hash using off-chain information of the transaction by leveraging a plurality conversion logics and algorithms

Certain exemplary embodiments of the system may utilize synchronized smart contracts 132 that once initiated or executed may trigger internal and external messaging systems, enabling reconciliation and reporting of transactions with external systems. Expanding on certain exemplary embodiments, the system via messaging protocols and/or engines may transmit information to regulatory authorities—FinCEN, GoAML, DTCC, NSCC, etc. for monitoring, reconciliation, reporting, and recording of a plurality type of transactions—i.e., AML/CFT transactions. A benefit of certain embodiments of the system is the fact that external facilities and entities may relay information communicated via messaging systems 112 and protocols to the gateway, triggering the initiation and execution of other smart contracts 132, minting of wallets 124, and transfer of funds, among other actions.

Certain exemplary embodiments of the system may use unified messaging protocols to report transactions to counterparty systems post-execution via messaging engines, providing standard details on executed (filled, canceled, restructured) transactions. Once the execution data is delivered—ensuring terms of the transactions are known, execution smart contracts 132 of the system may be executed. The execution of the transaction may trigger the reporting of said transaction data to external reporting and clearing facilities in the traditional system via financial communication protocols to reconcile off-chain information submitted by other parties to reporting facilities and regulatory authorities.

In certain exemplary embodiments of the system, smart contracts 132 may facilitate the storage of information tied to clearing and settlement, to enable the transfer of assets (cash/securities) to settle a transaction. (Meta) data from the execution and clearing may link the smart contracts 132 to reconcile transactions. The settlement smart contract 132 may be initiated based on the execution or previous smart contracts 132 associated with the transaction, and/or the execution, clearing, and settlement messages transmitted via (unified) messaging systems 112 and protocols to/from depository, clearing, and settlement institutions.

Expanding on certain exemplary embodiments of the system, clearing and settlement instructions may be sent by internal and external systems initiating and finalizing the transfer of digital, blockchain, and/or traditional assets/rights. A benefit of certain exemplary embodiments of the system is systems that may support a plurality settlement windows (T+2, intraday, real-time), allowing participants to settle transactions flexibly and dynamically. The disclosure may settle transactions multilaterally (multiple parties) or bilaterally (two parties). Multilateral transactions are preferably netted at the end of specific settlement windows. The system may also utilize multi-lateral netting. To retrieve instructions on behalf of an entity, the messaging systems 112 may send request messages to internal or external systems. Once the satisfactory output is received, the off-chain and/or on-chain transaction may settle.

The interoperability of the system may enable the use of assets and currencies in a plurality of derivatives—USD, GBP, EUR—on the blockchain, digital account, etc—creating fungibility of transfer and payment when settling transactions—irrespective of initial state—on-chain or off-chain. For example, a user may deposit money into a bank account and wallet, wherein the balance (or some variation of the balance) may be digitized and/or tokenized on a 1-v-1 basis, so the user may transact on a smart contract 132 embedded or enabled blockchains-assets may natively sit on any blockchain, or off-chain—creating streamlined conversion and swapping and transferring of assets.

Certain embodiments of the system may be compatible with execution, clearing, settlement, and recording happening off-chain. Transaction details and orders communicated via messaging system utilizing communication protocols to transmit information may be used to send and record data (or hash) from off-chain execution, clearing, and settlement activity, on-chain, in advance, point in time, or after the off-chain transactions any executing, clearing, and settling to provide a transparent, secure, and immutable audit trail for off-chain transactions. Said off-chain transaction data may be saved on-chain and off-chain, and in certain exemplary embodiments, the off-chain data may be used to recreate an on-chain transaction hash for reconciliation, among other things.

A benefit of certain exemplary embodiments of the disclosure, is a system that may utilize blockchains 104 and/or smart contracts 132, to enable firms who have not tokenized (replicated) assets on-chain to realize the transparency, speed, data integrity, and security benefits of recording and transacting on-chain. In certain exemplary embodiments of the system, messaging systems 112, smart contracts 132, and on-chain and off-chain wallets 122-124 of the system may interact to automatically record transaction data related to execution, clearing, and settlement.

In certain exemplary embodiments of the system, the system of the disclosure may enable third parties who may not have assets custodied by and/or within the system to tokenize, digitize, securitize, create, and issue assets via smart contracts 132 to benefit from the system without said assets being held or controlled the system. Manually, semi-automatically, or programmatically handling the transfer of assets/rights once the initiation and execution of on-chain processes pertaining to the execution, clearing, and settlement of assets. Off-chain and/or on-chain logic and rights of the system of the present disclosure and interacting systems utilizing the traditional, digital, and/or blockchain accounts and wallets escrow and/or transfer-related functions. An advantage of certain embodiments of smart contracts 132 utilized by the system is the ability to transfer, create, and burn assets.

The foregoing disclosure is not intended to limit the present system to the precise forms or particular fields of use in the disclosed embodiments. As a result, it is contemplated that a multitude of alternative embodiments and/or modifications to the present inventive disclosure, whether explicitly described or implied herein, are possible regarding the disclosure. Having described certain preferred exemplary embodiments of the present disclosure, a person of ordinary skill in the art will recognize that changes may be made in form and detail without departing from the scope of the present disclosure.

Accordingly, this description is to be considered illustrative and is for the purpose of teaching those skilled in the art the manner of making and using various embodiments of the present disclosure. It is to be understood that the forms of the disclosure herein shown and described are to be taken as representative embodiments. Equivalent elements or materials may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “wherein” used to describe, and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting the present disclosure. All joinder references (e.g., attached, simultaneously, aggregated, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily imply that two elements are directly connected to each other.

Additionally, all numerical terms, such as, but not limited to, “first”, “second”, “third”, “primary”, “master”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification. It will also be appreciated that one or more of the elements depicted in the drawings/figures can be implemented in a more separated or integrated manner, or even removed or rendered as inoperable in certain cases, as is useful in accordance with a particular application.

It may be apparent to one with skill in the art that the open banking, digital, and blockchain wallet systems may be provided using some or all of the mentioned features and components without departing from the spirit and scope of the system. It may also be apparent to the skilled artisan that the embodiments described above may be specific examples of a single broader invention that may have greater scope than any of the singular descriptions expressed. There may be many alterations made in the description without departing from the spirit and scope of the system.

What is claimed is:

1. A computer-implemented payment and banking system, comprising:
a gateway microservice system comprising proxying, authenticating, logging, routing, and monitoring functionality for managing systems, requests, and responses, enabling the orchestration of communication between a plurality of upstream and downstream systems;
an open and/or core banking system enabling functionality comprising authentication, transmission, and receipt of data and/or transactions between a plurality of upstream and downstream systems;
an account management system synchronized with the open and/or core banking system facilitating actions comprising buying, selling, transferring, depositing, withdrawing, and exchanging of fungible assets; and
a data storage system for storing, retrieving, updating, and synchronizing data.
The system of claim 1, wherein a transaction management system facilitates activities comprising monitoring, screening, and/or reporting transactions.
The system of claim 1, wherein the account management system is synchronized with at least one on-chain or off-chain identity or payment credential.
The system of claim 1, wherein (g) RPC nodes and APIs facilitate the transmission, receipt, reading, writing of data via private, consortium, and/or public blockchain systems.
The system of claim 4, wherein smart contracts systems facilitate on-chain and/or off-chain actions and/or control of on-chain and/or off-chain fungible assets.
The system of claim 1, wherein a messaging system utilizes standardized messaging protocols comprising ISO standards for interoperable communication.
The system of claim 1, wherein system processes are optimized utilizing supervised, semi-supervised, and/or unsupervised intelligence.
The system of claim 1, wherein a near-frequency communication system enables at least two devices embedded or compatible with near-frequency technology to have single or multiplexed communication and data exchange via encrypted and unencrypted protocols.
The system of claim 8, further comprising a near-frequency communication module for embedding and integrating NFC specifications for wireless short-range data exchange into NFC-compatible systems.
A computer-implemented payment and banking system, comprising:
a microservice middleware system with functionality comprising proxying, authenticating, logging, routing, and monitoring of systems, requests, and responses, managing upstream and downstream communication between a plurality of systems;
an open and/or core banking system utilizing at least one upstream system to enable functionality comprising authentication, transmission, and receipt of data and transactions between a plurality of systems;
a wallet and/or account system compatible with smart contracts systems facilitating on-chain and/or off-chain actions comprising buying, selling, exchanging, transferring, depositing, withdrawing, tokenizing, redeeming, and issuing of fungible and non-fungible assets;
smart contracts systems facilitating on-chain and/or off-chain transactions and/or control of on-chain and/or off-chain fungible and non-fungible assets;
(g) RPC nodes and APIs that transmit and receive data via private, consortium, and/or public blockchain systems; and
a centralized and/or decentralized storage system for storing, retrieving, updating, and synchronizing data.
The system of claim 10, wherein a transaction management system facilitates activities comprising monitoring, screening, and/or reporting transactions.
The system of claim 10, wherein the wallet and/or account system is linked to at least one on-chain or off-chain identity or payment credential.
The system of claim 10, wherein a near-frequency communication system enables at least two devices embedded or compatible with near-frequency technology to have single or multiplexed communication and data exchange via encrypted and unencrypted protocols.
The system of claim 13, further comprising a near-frequency communication module for embedding and integrating NFC specifications for wireless short-range data exchange into NFC-compatible systems.
The system of claim 10, wherein a messaging system utilizes standardized messaging protocols comprising ISO standards for interoperable communication.
The system of claim 10, wherein system processes are optimized utilizing artificial intelligence.
A computer-implemented payment and banking system enabling stablecoin and CBDC issuance, redemption, and management, comprising:
a gateway microservice system with functionality comprising proxying, authenticating, logging, routing, and monitoring for managing systems, requests, and responses, orchestrating communication between a plurality of upstream and downstream systems;
an open and/or core banking system enabling functionality comprising authentication, transmission, and receipt of data and/or transactions between a plurality of systems;
a custodial and non-custodial account management system compatible with smart contracts systems enabling on-chain and/or off-chain transactions comprising buying, selling, transferring, depositing, withdrawing, issuing, and redeeming of fungible assets, wherein said system, wholly or partly, synchronizes off-chain account management system balances via open and/or core banking with on-chain account management systems for facilitating the issuance of CBDCs and stablecoins, conversely, synchronizing on-chain account management systems balances via RPC nodes and APIs, enabling completely or partially, the redemption of CBDCs and stablecoins;
smart contracts systems facilitating on-chain and/or off-chain actions and/or control of on-chain and/or off-chain fungible and non-fungible assets;
a messaging system utilizing standardized communication protocols comprising ISO standards for interoperable sending and receiving of messages;
(g) RPCs nodes and APIs interfacing with private, consortium, and/or public blockchain systems for the transmission, receipt, reading, and writing of data; and
a centralized and/or decentralized storage system for storing, sharing, accessing, retrieving, updating, and synchronizing data.
The system of claim 17, wherein the account management system is linked to at least one on-chain or off-chain identity or payment credential.
The system of claim 17, wherein a near-frequency communication system enables at least two devices embedded or compatible with near-frequency technology to have single or multiplexed communication and data exchange via encrypted and unencrypted protocols.
The system of claim 19, further comprising a near-frequency communication module for embedding and integrating NFC specifications for wireless short-range data exchange into NFC-compatible systems.
